(19) United States
(12) Patent Application Publication
(10) Pub. No.: US 2024/0370959 A1
(43) Pub. Date: Nov. 7, 2024

(54) MULTI-LEVEL SEXUAL EDUCATION AND PRODUCT DELIVERY WEBSITE

(71) Applicant: LL Creations LLC, Brandon, FL (US)

(72) Inventors: Austin Madore, Brandon, FL (US); James Daniel, Roxboro, NC (US)

(73) Assignee: LL Creations LLC, Brandon, FL (US)

(21) Appl. No.: 18/688,779

(22) PCT Filed: Sep. 2, 2022
(86) PCT No.: PCT/US2022/042504

§ 371 Date: Mar. 3, 2024

Related U.S. Application Data
(60) Provisional application No. 63/246,167, filed on Sep. 20, 2021.
(60) Provisional application No. 63/311,360, filed on Feb. 17, 2022.

(51) Int. Cl. G06Q 50/22; G06Q 30/0601

(52) U.S. Cl. CPC G06Q 50/22; G06Q 30/0601

(57) ABSTRACT

A web-based service that provides a range of sexual education experiences, ranging from unobjectionable to pornographic, all may be moderated by the same worker is disclosed. In the unobjectionable to pornographic segments of training, various products will be discussed and used. These products may be purchased by clicking through a link on the video training page and being taken to a product page which is constructed to match the training page in its explicitness, i.e., unobjectionable to pornographic. An alternative embodiment of the present invention features a product page which is constructed to not match the training page in its explicitness, i.e., unobjectionable to pornographic.

This application takes benefit of U.S. Prov. App. No. 63/246,167 filed Sep. 20, 2021 and U.S. Prov. App. No. 63/311,360 filed Feb. 17, 2022 and incorporates both of these in their entirety by reference.

### FIELD OF THE INVENTION

The invention relates to a web-based service, that provides a range of sexual education experiences, ranging from unobjectionable to pornographic, all moderated by the same worker. Also, in the unobjectionable to pornographic segments of training, various products will be discussed and used. These products may be purchased by clicking through a link on the video training page and being taken to a product page which is constructed to match the training page in its explicitness, i.e., unobjectionable to pornographic. An alternative embodiment of the present invention features a product page which is constructed to not match the training page in its explicitness, i.e., unobjectionable to pornographic.

### BACKGROUND OF THE INVENTION

The invention relates to a webserver and web-service enabling software that offers a range of sexual education experiences, all dealing with the same topic, each range of the sexual education experience varying from unobjectionable to pornographic. Moreover, the range of sexual education experiences may be moderated by the same sexual health worker.

Also, during the segments of training, various products will be discussed and used. These products may be purchased by clicking through a link on the training page and being taken to a product page.

Also, in some legal settings, referrals to sexual health workers may occur. For example, a referral to an individual sexual worker, or to the worker moderating the class may be made. Sexual health workers may be understood to be massage therapists, male and female prostitutes, etc.

In the prior art, numerous web-services exist that offer sexual health training. However, no web-service exists that offers sexual training at a variety of explicitness levels often by the same, or different, worker. Also, no such web-service exists that connects to, and offers for sale, products appearing in the training segments. Also, no such web-service exists that offers a referral to a sexual worker.

Accordingly, a first embodiment of the present invention is directed towards a web-service that offer levels of sexual health training in increasing explicitness levels.

Also, a second embodiment of the present invention is directed towards a web-service in which products may be purchased by clicking through a link on a training page and being taken to a product page.

Also, a third embodiment of the present invention is directed towards a web-service in which referrals to sexual workers may occur. For example, a referral to an independent, individual sexual worker, or to the worker moderating the class may be affected.

### SUMMARY OF THE INVENTION

The present invention is comprised of a webserver and web-service enabling software that offers a range of sexual education experiences, all dealing with the same topic, in which each range of the sexual education experience varies from unobjectionable to pornographic. Moreover, the range of sexual education experiences may be moderated by the same worker. Sexual health workers may be understood to be massage therapists, male and female prostitutes, etc.

The first embodiment of the present invention is directed towards a web-service in which sexual health teaching occurs in an unobjectionable environment. Products may also be purchased. Moreover, a referral to the sexual health worker may be received. The range of sexual education experiences may be moderated or performed by the same sexual health worker.

The second embodiment of the present invention is directed towards a web-service in which sexual health teaching occurs in a suggestive environment. Products may also be purchased. Moreover, a referral to the sexual health worker may be received. The range of sexual education experiences may be moderated or performed by the same sexual health worker.

The third embodiment of the present invention is directed towards a web-service in which sexual health teaching occurs in a pornographic environment. Products may also be purchased. Moreover, a referral to the sexual health worker may be received. The range of sexual education experiences may be moderated or performed by the same sexual health worker.

Any number of environments in which sexual health teaching occurs may be used at any level of explicitness desired. At all levels however the range of sexual education experiences may be moderated or performed by the same sexual health worker.

### BRIEF DESCRIPTION OF THE DRAWINGS

FIG. 1 is a flowchart showing how the present invention functions dealing with unobjectionable sexual health teaching, descriptions of products, and links to potentially the same unitary sexual health worker.

FIG. 2 is a flowchart showing how the present invention functions dealing with suggestive sexual health teaching, descriptions of products, and links to potentially the same unitary sexual health worker.

FIG. 3 is a flowchart showing how the present invention functions dealing with pornographic sexual health teaching, descriptions of products, and links to potentially the same unitary sexual health worker.

### DETAILED DESCRIPTION OF THE INVENTION

The present invention is comprised of a webserver and web-service running on the web server that offers a range of sexual education experiences, all dealing with the same topic selected from a multiplicity of different topics, in which each range of the sexual education experience varies from unobjectionable to pornographic. Moreover, the range of sexual education experiences may be moderated or performed by the same unitary sexual health worker.

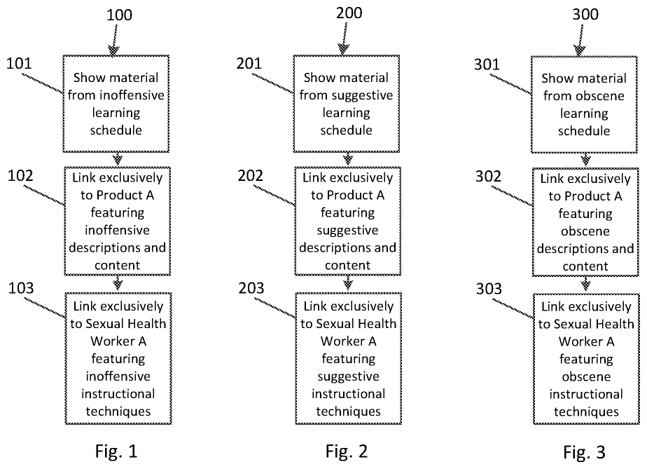

Turning now to FIG. 1, the first embodiment of the present invention is directed towards a web-service in which sexual health teaching occurs in an unobjectionable environment (100). Such an environment is one in which the material is presented in a factual, inoffensive manner (101). Products may also be purchased (102). Moreover, a referral to potentially the same sexual health worker may be received (103). Such an environment is one in which the descriptions and imagery presented when arranging the referral are factual and inoffensive. The range of sexual education experiences are potentially moderated or performed by the same unitary sexual health worker.

Referring now to FIG. 2, the second embodiment of the present invention is directed towards a web-service in which sexual health teaching occurs in a suggestive environment (200). Such an environment is one in which the material is presented in a suggestive, titillating manner (201). Associated products may be purchased (202). Moreover, a referral to potentially the same sexual health worker may be received (203). The range of sexual education experiences are moderated or performed by potentially the same unitary sexual health worker.

Referring now to FIG. 3, the third embodiment of the present invention is directed towards a web-service in which sexual health teaching occurs in a pornographic environment (300). Such an environment is one in which the material is presented in an obscene, pornographic manner (301). Associated products may also be purchased (302). Moreover, a referral to potentially the same sexual health worker may be received (303). The range of sexual education experiences are potentially moderated or performed by the unitary sexual health worker.

It will be obvious to one having skill in the art, that a multiplicity of individuals may perform the services in lieu of the same sexual health worker. In other words, the potentially same sexual health worker may in fact be a multiplicity of sexual health workers.

The term “sexual education” as used in ¶¶[0002], [0003], [0010]-[0014], and [0018]-[0021] may refer to sexual wellness video performances conducted by experts on camera, live or pre-recorded, which deal with the psychology of sex, specifically “turn-ons” and “turn-offs” and feature a discussion using pornographic terms and concluding with discussions and links to products available on pornhub.com and xhamster.com.

The web-service feature discussions and presentations range from wellness-directed discussions to pornographic-directed discussions as related to sexual activity. Moreover, the web-service presents links between these discussions to products available on third-party websites such as pornhub.com and xhamster.com. These linkages may be graded in intensity such that wellness related discussions of sexual health link to wellness-related products and pornographic-related discussions link to pornographic products.

The term “link” (or button) as used in ¶¶[0002], [0004], [0008], and [0015]-[0017] may be a link to a third-party website such as pornhub.com or xhamster.com.

The link (or button) may be used to explore products, videos, performers, or links to other products, videos, or performers.

The link (or button) may be per performer, per video, or per video clip and may in turn be a link to a biography, a third-party website such as pornhub.com, a link to a toy used in a video, a link to a toy sponsored by a performer, or a link to a particular sexual wellness video hosted on, or available through, the website.

The link (or button) may be to a questionnaire or survey concerning new products, new toys, new positions for sexual activities, and new videos. Links to new videos may identify the performers and/or the practices portrayed in the video.

Moreover, on a web page presenting a performer, or a product, or a service, a link (or button) may be presented to solicit a call via the telephone or via the Internet (Zoom.com, etc.). Similarly, a service a link (or button) may be presented to solicit a physical visit by an expert, or his or her surrogate, or some other sexual health worker, to the individual clicking the link or button.

Moreover, on a web page that presents a performer, a product, or a service link freemium/private (unpaid/paid) content may be presented. As the user uses or “follows” channels, recommended videos, crowdsourced videos, and curated videos will show up indexed to a similar video or product.

Users may review sex toys that are presented on the website. Reviews can be professionally provided by the manufacturer, crowdsourced by consumers, or provided by experts.

Experts may be paid multiple ways: A fixed commission; A smaller commission with a percentage of sales from customers; Sales from customers with a percentage going to the website operator; An hourly (or some other time-based increment) rate for services rendered, and so on.

Experts may provide services by several methods: 1:1 (video or remote) sessions; Seminars; Webinars; 1:1 (in-person) sessions; and, Prostitution.

The website features a personal library for customers to: Purchase videos from experts or crowdsourced users; Recommend products based on items the customer is, or has, looked at; A mobile application with geolocation (GPS-based service) to identify where and when individuals go to certain places; and, A histogram or other display showing the locations where a customer goes.

The website utilizes AWS (Amazon Web Services or a similar web-hosting service) for hosting the webservice while using local web servers to store the personalized data. Users can make and find favorite videos, make playlists, and get recommended videos based on viewing history. Experts and third parties may offer ad space within the website.

AWS (or a similar web-hosting service) is well understood to be a collection of computing devices or processors (central processing units or CPUs) each equipped with memory and a controlling program. The controlling program may be changed from time to time. The collection of computing devices or processors is controlled by a supervisory processor.

The supervisory processor is well understood to be a collection of computing devices or processors (central processing units or CPUs) each equipped with memory and a supervisory program. The supervisory program may be changed from time to time. The supervisory program dispatches jobs requested (website service enquiries, database queries, retrieval, and display of videos, etc.) by end users (using a web browser, an application program, etc.) to one of the controlling programs which then processes the job and sends the results back to the supervisory program for return to the end user. The controlling program may also send data directly to the end user.

What is claimed is:

1. A web-hosting service wherein the controlling program presents a sexual health education website
a) wherein sexual education experiences on a single topic selected from a multiplicity of topics is presented with each of said sexual education experiences taught or presented at different levels of sophistication and intensity wherein said sophistication and intensity of each of said sexual education experiences is selected in sequence from:
a. unobjectionable material;
b. suggestive material; and
c. pornographic material;
b) wherein said sexual education experiences are moderated by a sexual health worker; and
c) wherein the customer purchases a good in conjunction with accessing one or more of said sexual education experiences offered in sequence at different levels of sophistication and intensity.

2. A web-hosting service wherein the controlling program presents a sexual health education website of claim 1, wherein the sexual education experiences are moderated by the same sexual health worker.

3. A web-hosting service wherein the controlling program presents a sexual health education website of claim 1, wherein the sexual education experiences are moderated by different sexual health workers.

4. A web-hosting service wherein the controlling program presents a sexual health education website of claim 1, in which links to products for retail sale are provided.

5. A web-hosting service wherein the controlling program presents a sexual health education website of claim 1, in which at least one referral to a sexual health worker is provided.

6. A web-hosting service wherein the controlling program presents a sexual health education website of claim 5, in which the sexual health worker is a massage therapist.

7. A web-hosting service wherein the controlling program presents a sexual health education website of claim 5, in which the sexual health worker is a prostitute.

8. A web-hosting service wherein the controlling program presents a sexual health education website of claim 5, in which the sexual health worker is paid a fixed commission.

9. A web-hosting service wherein the controlling program presents a sexual health education website of claim 5, in which the sexual health worker is paid a commission based on the percentage of sales from customers.

10. A web-hosting service of claim 5 wherein the sexual health worker is paid a percentage based on sales and a percentage going to the website operator.

11. A web-hosting service wherein the controlling program presents a sexual health education website of claim 5, in which the sexual health worker is paid by the hour or for some other increment of time.

12. A web-hosting service comprising
a) a collection of computing devices or processors (central processing units or CPUs) each equipped with memory and a controlling program;
b) wherein the controlling program is controlled by a collection of computing devices or processors (central processing units or CPUs) each equipped with memory and a supervisory program;
a. wherein the supervisory program oversees and controls the controlling programs;
b. wherein the controlling program offers sexual education experiences on a single topic selected from a multiplicity of topics;
c. wherein each sexual education experience is presented in varying sophistication and intensity and the sexual education experiences are selected in sequence from:
i. unobjectionable material;
ii. suggestive material; and
iii. pornographic material;
d. wherein the sexual education experiences are moderated by a sexual health worker.

13. A web-hosting service of claim 12 wherein the sexual health worker is a massage therapist.

14. A web-hosting service of claim 12 wherein the sexual health worker is a prostitute.

15. A web-hosting service of claim 12 wherein the sexual health worker is paid a fixed commission.

16. A web-hosting service of claim 12 wherein the sexual health worker is paid a commission based on the percentage of sales from customers.

17. A web-hosting service of claim 12 wherein the sexual health worker is paid a percentage based on sales and a percentage going to the website operator.

18. A web-hosting service of claim 12 wherein the sexual health worker is paid a by the hour or some other increment of time.
